(19) United States
(12) Patent Application Publication
(10) Pub. No.: US 2008/0236355 A1
(43) Pub. Date: Oct. 2, 2008

(54) Fences for table saws

(76) Inventors: Stephen F. Gass, Wilsonville, OR (US); J. David Fulmer, Tualatin, OR (US)

Correspondence Address: SD3, LLC, 9564 S.W. Tualatin Road, Tualatin, OR, 97062, US

(21) Appl. No.: 12/077,576

(22) Filed: Mar. 19, 2008

Related U.S. Application Data
(63) Continuation of application No. 11/027,254, filed on Dec. 31, 2004.
(60) Provisional application No. 60/533,852, filed on Dec. 31, 2003.

(51) Int. Cl. B26D 7/06

(52) U.S. Cl. 83/438

(57) ABSTRACT

Table saw fence systems adapted to be operatively positioned on a table saw to guide movement of a work piece on the table saw are disclosed. In some embodiments, the fence system includes a bracket adapted to be secured to the table saw and a guide rail adapted to be secured to the bracket. The bracket holds the guide rail a distance away from the table saw to define a channel between the guide rail and the table saw, and a portion of a fence fits into the channel. The position of the guide rail on the bracket is adjustable to minimize rocking of the fence as it slides along the guide rail.

### CROSS-REFERENCE TO RELATED APPLICATIONS

This application is a continuation of U.S. patent application Ser. No. 11/027,254 filed Dec. 31, 2004, which in turn claimed the benefit of and priority from U.S. Provisional Patent Application Ser. No. 60/533,852, which was filed on Dec. 31, 2003. The complete disclosures of these applications are hereby incorporated by reference in their entireties for all purposes.

### FIELD OF THE DISCLOSURE

The present disclosure relates to table saws, and more particularly, to fences for table saws.

### BACKGROUND

A table saw is a power tool that includes a work surface or table and a circular blade extending up through the table. A person uses a table saw by moving a work piece against and past the spinning blade to cut the work piece. Typically, an attachment called a fence is positioned on the top of the table to provide a guide for the work piece as the work piece is slid past the blade. The present document discloses fences for table saws.

### BRIEF DESCRIPTION OF THE DRAWINGS

FIG. 1 is an isometric view of a table saw with a fence according to the present disclosure.

FIG. 2 is an isometric view of the fence of FIG. 1 and a rail and tabletop of a table saw.

FIG. 3 is a perspective view of a fence according to the present disclosure.

FIG. 4 is a cross-sectional view of the fence of FIG. 3 taken along the line 4-4 in FIG. 3.

FIG. 5 is a rear isometric view of a fence according to the present disclosure.

FIG. 6 is a bottom plan view of a fence according to the present disclosure.

FIG. 7 is a cross-sectional view of another fence according to the present disclosure.

FIG. 8 is a cross-sectional view of another fence according to the present disclosure.

FIG. 9 is a front elevation view of a fence according to the present disclosure.

FIG. 10 is a front isometric view of the fence of FIG. 9.

FIG. 11 is a side elevation view of the fence of FIG. 9.

FIG. 12 is a side cross-sectional view taken along the line 9-9 in FIG. 3.

FIG. 13 is an isometric view of a fence according to the present disclosure.

FIG. 14 is a fragmentary cross-sectional detail of a portion of a clamping mechanism that may be used with fences according to the present disclosure.

FIG. 15 is a fragmentary cross-sectional detail of a portion of another clamping mechanism that may be used with fences according to the present disclosure.

FIG. 16 is an isometric view of a fence according to the present disclosure.

FIG. 17 is a fragmentary isometric detail taken along the area 17 of FIG. 16.

FIG. 18 is a fragmentary isometric detail taken along the area 18 of FIG. 1.

FIG. 19 is an isometric view of another fence according to the present disclosure.

FIG. 20 is a fragmentary cross-sectional view of a portion of a fence according to the present disclosure clamped upon a rail of a saw.

FIG. 21 is a fragmentary cross-sectional detail of a portion of yet another clamping mechanism that may be used with fences according to the present disclosure.

### DETAILED DESCRIPTION AND BEST MODE

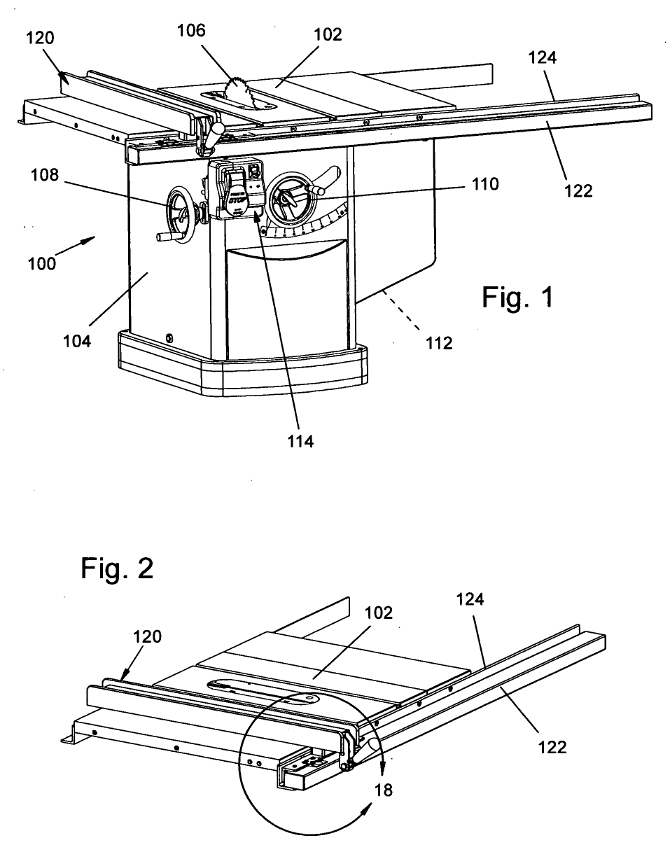

FIG. 1 shows a table saw 100. The illustrative example is often called a cabinet saw or tilting-arbor saw. The saw includes a table, or tabletop, 102 on which a work piece may be cut. The table is mounted on a cabinet or other suitable stand or platform 104. A blade 106 extends up through a slot in the table to cut a work piece. A motor assembly 112 is adapted to drive the rotation of the blade. Motor assembly 112 may be supported in any suitable location relative to the blade, such as within or adjacent the cabinet. Hand wheels 108 and 110 may be turned to adjust the tilt of the blade relative to the tabletop and the elevation of the blade (the height the blade extends above the table). A switch assembly 114 containing at least one switch, such as an on/off switch, provides a user with a mechanism for selectively providing power to the motor and causing the blade to spin.

In operation, a user makes a cut by pushing a work piece on the table against and past the spinning blade. It is within the scope of the present disclosure that table saw 100 may take a variety of forms, such as larger and/or smaller scale versions of the illustrative saw shown in FIG. 1, as well as a configuration in which at least the table and/or cabinet are differently shaped, sized and/or configured. For example, some table saws that typically are smaller than the illustrated example of saw 100 are referred to as contractor saws, job-site table saws, and/or bench-top table saws. Examples of table saws that typically are larger than the illustrated example of saw 100 include panel saws and sliding table saws.

FIGS. 1 and 2 show a fence 120 positioned on table 102. The fence rests on the table and may be slid laterally along the table toward or away from the blade to accommodate work pieces of different sizes. The fence is adapted to slide upon or otherwise to be positioned upon a rail, or guide, 122. Rail 122 may also be referred to as a guide rail that is adapted to guide the sliding motion of the fence as the subsequently described cross bracket of the fence slides along the rail and is selectively secured in a selected position thereupon by a clamping mechanism. In the illustrated example, rail 122 is mounted on a bracket 124, which is secured to table 102. As mounted on bracket 124 or otherwise coupled to the table, rail 122 is spaced away from the table to define an elongate track, or slide path, that extends along the length of the table between the rail and the table. As discussed in more detail herein, the fence includes a cross bracket that is adapted to extend within the track as the fence is operatively positioned on the table. As discussed in more detail herein, the fence includes a clamp assembly that is adapted to selectively clamp upon or otherwise engage the front rail to releasably secure the fence in a selected position relative to the table. The clamp assembly is therefore used to retain the fence in a selected position relative to the table while a work piece is being cut with the saw.

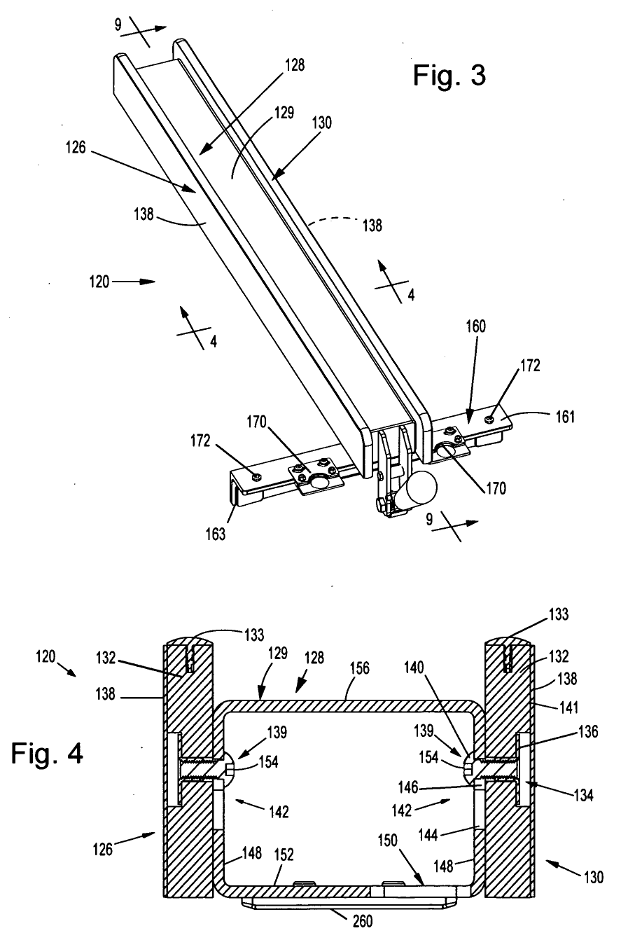

As indicated in FIG. 3, the fence includes at least one face, or face plate, that extends up from the table top at 90-degrees relative to the tabletop. For example, a face 126 is indicated in FIG. 3 and includes an engagement surface 138, which is typically a smooth, level surface. Preferably, the surface is sufficiently smooth and/or slick to resist binding or catching of the work piece against the surface as the work piece is slid in contact with the engagement surface while being cut. In many uses of the saw, a person will position a work piece on the table with one edge or surface of the work piece against surface 138, and then slide the work piece past the spinning blade while maintaining the edge of the work piece against the engagement surface of face 126. In order to obtain precise and straight cuts, the face of the fence should be parallel to the blade, preferably along the entire length of surface 138.

The illustrated fence also includes an elongate support 128 onto which face plate 126 is mounted. It is important for support 128 to be sufficiently rigid that face plate 126 remains parallel to the blade during use of the saw. Keeping the fence parallel to the blade is necessary to make smooth, straight cuts in the work piece. If support 128 deflects or flexes, then the face plate will move and the fence will not be as precise as it otherwise would be. The rigidity of support 128 is affected by such factors as the material or materials from which the support is made, the wall thickness of the material, the construction of the support, etc. In the illustrative example, support 128 takes the form of an elongate tube, or tubular member, 129, although other shapes, geometries and constructions may be used without departing from the scope of the present disclosure. As an illustrative (non-exclusive) example, a steel tube with 2-3 millimeter thick walls has proven effective.

As shown in FIGS. 1-3 and as indicated in FIG. 3, the illustrated fence includes a face plate 126 mounted on one side of support 128, and a second face plate 130 mounted on the opposite side of the support. Each face plate preferably includes an engagement surface 138. As shown, the engagement surfaces are oriented in a generally opposed, oppositely facing configuration. Work pieces to be cut on the saw are positioned against face plate 126 when the fence is to the right of the saw blade relative to a person using the saw, and work pieces are positioned against second face plate 130 when the fence is to the left of the saw blade. While it is within the scope of the present disclosure to include only a single face plate, fence 120 will typically include a pair of face plates. The support and face(s) may collectively be referred to as a work piece guide assembly, or the work piece guide portion of the fence.

Face plates 126 and 130 may have any suitable construction for providing a guide for the work pieces to be cut. As discussed, the faces preferably include a smooth and flat engagement surface 138 that is positioned to be contacted by a work piece being cut with the saw. As also discussed, it is important that the fence, including surfaces 138 thereof, be sufficiently rigid and/or sufficiently supported to provide an accurate guide that does not flex or deform while being used. Surface 138 may be integrally formed with the rest of faces 126 and 130 or they may be separately formed and thereafter assembled with the other structure forming the faces.

An illustrative example of a suitable construction for the faces is shown in FIG. 4. As shown, each face 126 and 130 includes a core, or body, 132 to which surface 138 is secured. As also shown, each face includes an optional trim portion 133 that extends around at least the upper surface, or periphery, of the face. When present, trim portion 133 may provide a smooth surface along which a user's hand may be slid as the saw is used. An illustrative example of a suitable material for core 132 is high quality plywood, and an illustrative example of a suitable material for surface 138 is melamine, although others may be used without departing from the scope of the present disclosure. As another example, core 132 may be formed from high-pressure laminates that are adapted to retain their shape when subjected to the temperate and/or humidity fluctuations encountered in the operating environment in which fence 120 is used.

When a fence according to the present disclosure includes one or more faces, such as face 126 and/or 130, and a support 128, such as the tube indicated at 129 in FIG. 4, the face(s) and tube may be secured together in any suitable permanent or releasable fastening mechanism. As used herein, a permanent fastening mechanism refers to a fastening mechanism in which at least a portion of the fastening mechanism and/or at least one of the structures that are secured together by the fastening mechanism are damaged or destroyed when the structures are separated. As used herein, a releasable fastening mechanism refers to a fastening mechanism that is configured to be repeatedly used to secure two or more structures together without destroying or damaging the fastening mechanism or the structures that are secured together thereby.

In many embodiments, it may be desirable for the faces to be adjustably and/or removably coupled to the support, such as by one or more releasable fastening mechanisms. For example, if a face is damaged, it may be replaced with a new face. Similarly, by providing a face that is adapted to be adjustably positioned relative to the support and thereafter secured in a selected position, a user may ensure that the face is properly positioned, or aligned, relative to the rest of the fence and/or the table. An illustrative, non-exclusive example of a suitable fastening mechanism 139 for securing faces 126 and 130 to support 128 is shown in FIG. 4. As shown, holes 134 are cut or otherwise made in the core 132 of each face. A T-nut, or threaded insert 136 is positioned in each hole. In the illustrative example, the T-nuts include barbs that cut into the plywood or other material from which the core is formed to hold the nuts in place and to prevent the nuts from rotating relative to the core. Engagement surface 138 is laminated or otherwise secured over the outer face 141 of the core and over holes 134.

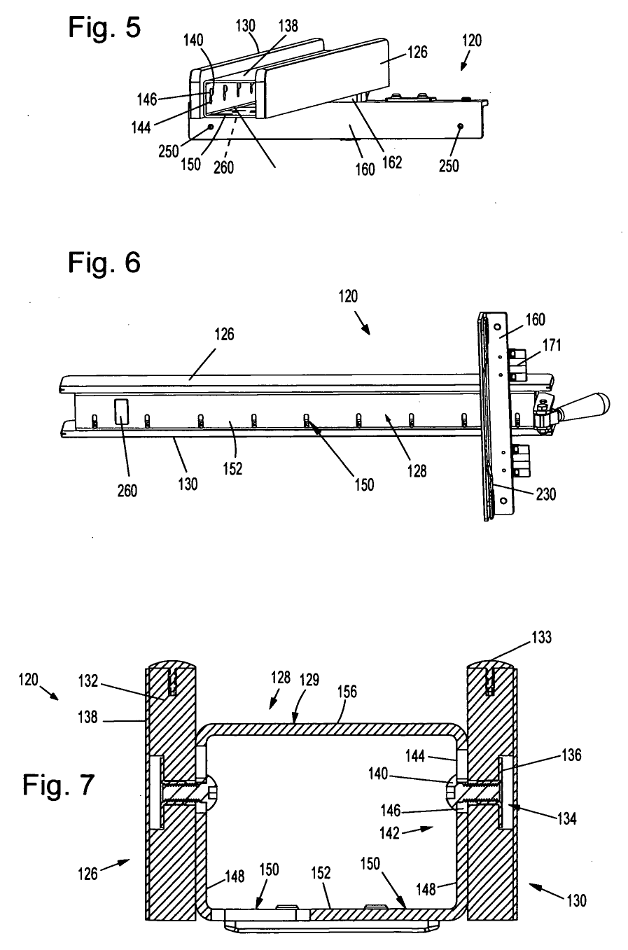

A screw 140 is then threaded into each T-nut far enough to support the screw but with the head of the screw remaining out and away from the core. Corresponding holes 142 are cut into the sides of support 128, one hole for each screw head. Holes 142 are shaped to include a first portion 144 large enough for the head of screw 140 to pass through, and a second portion 146 smaller than the head of screw 140, as shown in FIGS. 4 and 5. It is within the scope of the present disclosure that any other suitable receiver for a screw or other utilized fastener may be used in place of inserts 136. In the illustrated example, screw 140 includes a head and a shaft extending from the head. The shaft is adapted to be received by the insert or other receiver to secure the screw and the insert together. When the shaft of the screw of other fastener is inserted sufficiently into the insert or other receiver, the fastening mechanism formed by the insert and screw releasably secures the face to the support.

In the illustrative example shown in FIG. 4, support 128 takes the form of a hollow tube 129 that includes opposed sidewalls 148, a bottom surface 152, and a top surface 156. As discussed, the tube includes a plurality of holes 142 extending along the sidewalls 148 of the tube. Also shown in FIG. 4 are holes 150 that extend through a bottom surface 152 of the tube. Holes 150 provide access to the heads of the screws associated with at least one of the faces by a suitable tool that is adapted to engage and turn the screws. In the illustrated example, the screws have hex-shaped sockets 154 that are adapted to receive the tip of a hex wrench, such as a Bondhus™ hex wrench, or other tool or driver that is inserted through either holes 150 or holes 142 (if a face is not mounted to the sidewall of the tube through which the holes extend). Any suitable screw or other fastening configuration may be used without departing from the scope of the present disclosure. Holes 150 may be referred to as access ports.

In the illustrated example shown in FIGS. 4-6, holes 150 are oriented to provide access to the screws extending through a selected sidewall of the tube, namely the sidewall distal the holes. For example, in the illustrated example shown in at least FIG. 4, face plate 130 may be mounted onto support 128 by positioning the face plate so that its screws 140 extend into the larger portions of corresponding holes 142 in support 128. The face plate is then moved relative to the support so that the screws move into the smaller portions of holes 142 with the screw heads against the inside surface of the support. The screws in face plate 130 may then be tightened to secure the face plate to the support. The screws are tightened by extending a driver through holes 142 on the side of support 128 opposite face plate 130.

Face plate 126 may then be mounted on support 128 in the same manner, except holes 142 opposite face plate 126 would be blocked by face plate 130, so a driver could not extend through those holes to tighten the screws. Therefore, holes 150 are used to provide access to the screws associated with face plate 126. As discussed, holes 150 are positioned sufficiently distant from face plate 126 so that a driver may be inserted through the holes to engage and tighten screws 140 to secure face plate 126 in place.

In the illustrated embodiment that is perhaps best seen in FIG. 6, nine evenly spaced screws, approximately 3 to 4 inches apart, are used to secure each face plate onto support 128. Nine screws are used to hold the face plate flat against the support along the entire length of the support and to prevent bowing of the face plates. Other numbers of screws or other suitable fastening mechanisms may be used without departing from the scope of the present disclosure. When screws 140 are used, the optimum number of screws may vary, such as according to one or more of the material used to form the faces and/or the support, the thickness of the faces and/or the support, the length of the faces and/or the support, user preferences, etc.

At times it is desirable to use a face plate with a different dimension, such as a higher or lower vertical dimension, or shape, or it may be necessary to replace an old face plate with a new one due to wear. Changing a face plate may be accomplished by reversing the procedure described above and then installing the new face plate. While other constructions and/or fastening mechanisms may be used within the scope of the present disclosure, a benefit of the above-discussed construction is that the faces may be adjusted relative to the support and/or removed and replaced relative to the support without damaging or removing surfaces 138. This construction therefore also enables the face to have a monolithic or other configuration in which surface 138 and core 132 are integrally or permanently secured together and yet the face may still be adjusted and/or removed and replaced relative to the support without damaging the face.

It is within the scope of the present disclosure that other constructions and/or assembly methods for the face(s) and support may be used. For example, in the context of a fence that includes two faces secured by a releasable fastening mechanism in the form of the plurality of screws discussed above, the orientation of holes 150 relative to the respective faces may be reversed, in which case the faces would be installed in the reverse order from that described above. As a further variation, support 128 may include a larger hole that is sized to enable a driver to extend through the hole and access corresponding screws for each face. As still another variation, support 128 may include a plurality of holes that are sized and/or positioned to provide access to the heads of the screws for each face. For example, a pair of spaced apart holes may be used in place of each of the illustrated holes. Holes 150 may additionally or alternatively extend through the top surface of the support. Similarly, the illustrated orientation of holes 142 may be reversed, such that portion 146 extends below portion 144 instead of above portion 144.

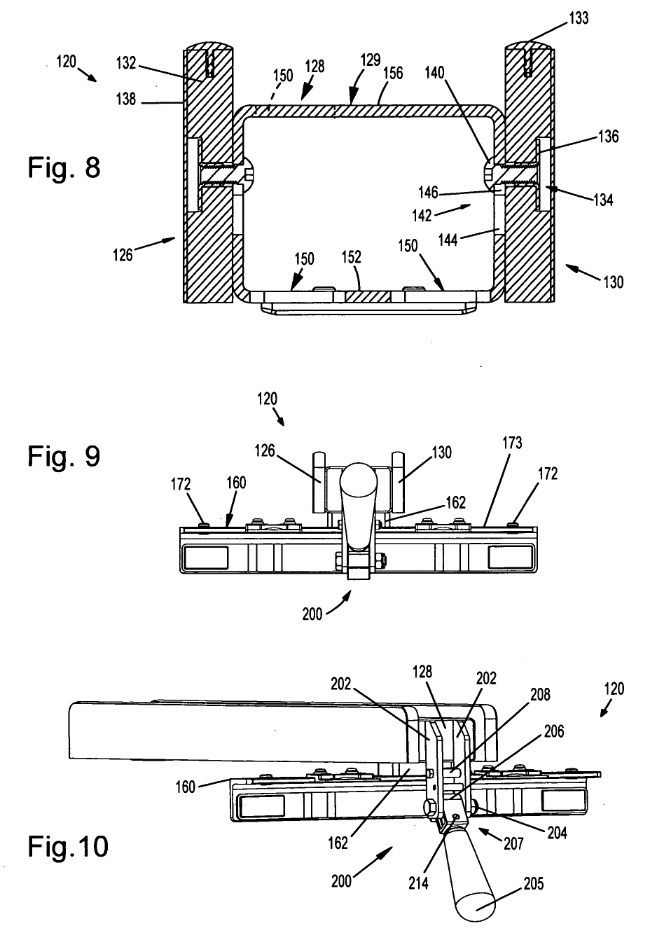

Graphical examples of these non-exclusive additional examples are shown in FIGS. 7 and 8. In FIG. 7, hole 150 is sized to permit access to either of the illustrated set of screws. FIG. 7 also demonstrates the above-discussed inverted orientation of holes 142. In FIG. 8, a pair of holes 150 are shown extending through the lower surface 152 of the support, with a hole 150 indicated in dashed lines extending through the top surface 156 of the tube to provide a graphical representation that such a configuration is within the scope of the present disclosure. In FIGS. 5-8, and in many of the subsequently discussed figures, reference numerals of elements that are introduced and described throughout the present disclosure may be included for the purpose of consistency throughout the drawings. Similarly, the reference numerals may be used in the following discussion without having each use of a reference numeral be indicated in each figure in which the corresponding element is shown.

In FIGS. 4-6, fence 120 is shown including an optional slide plate 260 that is attached to the bottom surface 152 of support 128 distal from the subsequently discussed clamping mechanism. Slide plate 260 is adapted to slide along table 102 when a user adjusts the position of the fence relative to the table. Slide plate 260 preferably lessens the friction that otherwise would be encountered if the lower bottom surface of the support was slid along the table and/or protects the table from being scratched or otherwise damaged as the fence slides along the table. A suitable material for slide plate 260 is a hard, low friction plastic, but others may be used. When present, slide plate 260 may be adjustable relative to the bottom surface of the support, or it may extend in a fixed position relative to the support.

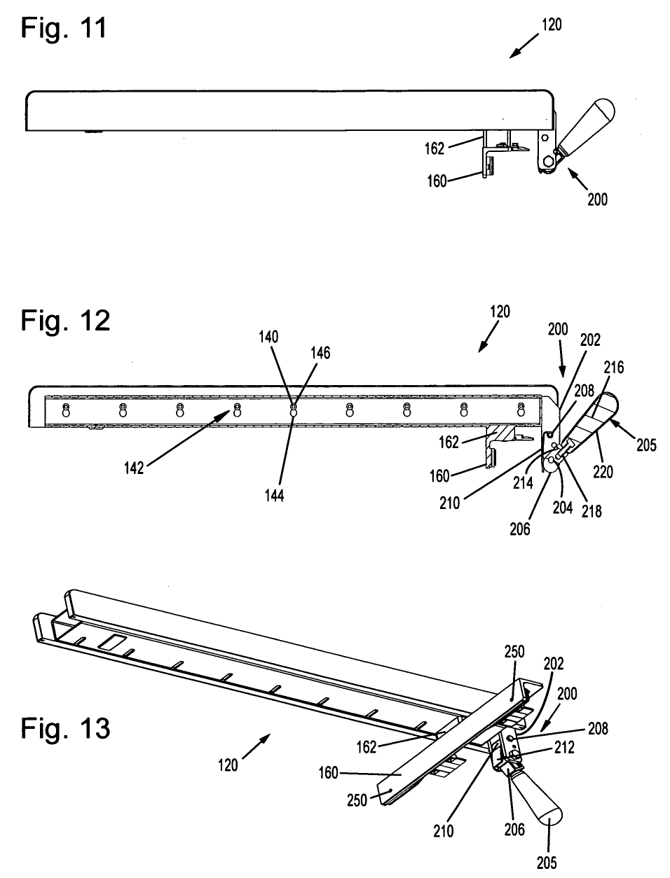

As shown in FIGS. 3 and 5-6, one end of support 128 is mounted on a cross bracket 160, which gives the fence a T-shaped configuration. A fence of this type may be referred to as a T-square or T-style fence. Bracket 160 may also be described as being coupled to the work piece guide assembly. This coupling may include a direct connection thereto and/or at least one intermediate linking member. Bracket 160 is positioned perpendicular to the longitudinal axis of support 128 and preferably is formed from a sturdy material that provides support and stiffness to the fence. An illustrative example is steel, such as in the form of angle iron, although others may be used. As illustrated in FIG. 3, bracket 160 includes horizontal and vertical portions 161 and 163 that extend at right angles relative to each other. Horizontal portion 161 faces, and optionally engages, the top surface of rail 122 when the fence is used. Horizontal portion 161 may also be described as being a portion of bracket 160 that extends generally parallel to the plane (top surface) of table 102. Vertical surface 163 is adapted to extend within the track, or guide path, defined between the rail and table of the table saw when the fence is used, and the surface is selectively drawn toward and away from the table-facing surface of rail 122 as the fence's clamping mechanism is adjusted to configure the clamping mechanism between its clamped and unclamped positions. Vertical surface 163 may be described as extending perpendicular to the plane of the table. As shown in FIGS. 9-12, the fence may include a spacer 162 that extends between the support and the bracket. Spacer 162 provides an illustrative (non-exclusive) example of a linking member. Bracket 160 is configured so that it may rest and slide on rail 122, with an illustrative operative position of the fence on saw 100 shown in FIGS. 1 and 2. Spacer 162 is sized so that the bracket may rest on the top of rail 122, and the bottom surface of support 128 may rest on the saw's tabletop.

Fence 120 also includes a clamping mechanism that is adapted to releasably engage rail 122 to secure the fence in a selected position relative to the table. The clamping mechanism preferably provides sufficient support to the fence to retain the fence in a selected orientation relative to the table, and perhaps more particularly, relative to the plane of the saw's blade, along the length of the fence's support. An example of a suitable clamping mechanism 200 is shown in FIGS. 9-13 and indicated generally at 200, although it is within the scope of the present disclosure that any suitable mechanism for selectively engaging rail 122 to secure the fence in a selected position relative to the table may be used. As indicated in FIGS. 10 and 12, the illustrative example of a suitable clamping mechanism 200 includes arms 202 that extend generally downwardly from support 128. A pivot pin 204 is coupled to the two arms, such as by being mounted between a pair of arms 202, and a handle 205 is pivotally mounted on pin 204. Handle 205 may have any suitable size and/or construction. Preferably, handle 205 is sized and constructed to provide a comfortable gripping surface that a user can readily grasp in the user's hand to tighten or loosen (i.e., clamp or release) the clamping mechanism. As an illustrative, non-exclusive example, handle 205 may be formed by molding plastic 216 over a bolt 218 and then molding or placing a soft grip surface 220 over the plastic. This illustrative construction is shown in FIG. 12. As also shown in FIG. 12, the bolt may extend from the plastic so that it may screw into a threaded hole in a cam surface 206 to join the handle and the cam surface.

In the illustrative example shown in FIGS. 9-13, the handle is pivotal in a vertical, or generally vertical, plane, with the handle urging the clamping mechanism into an engaged, or clamped, position when the handle is pivoted downward, and the handle urging the clamping mechanism to a released, or unclamped, position when the handle is pivoted upward. In some embodiments, it may be desirable for the clamping mechanism to include a retention mechanism 207 that is adapted to retain the handle in a selected orientation relative to the rest of the fence. For example, when a user positions the handle so that the clamping mechanism is in an unclamped configuration, such as shown in FIGS. 9 and 11-12, the retention mechanism may be adapted to prevent the handle from pivoting downward under the force of gravity and thereby causing the clamping mechanism to engage, or more firmly engage, the rail of the saw.

In FIG. 10, an example of a retention mechanism 207 is shown in the form of a magnet 214 that is mounted on and/or extends within, handle 205 and which is positioned to engage a metallic portion of the clamping mechanism to retain the handle in an upwardly extending orientation. Additionally or alternatively, a suitably positioned portion of the clamping mechanism may include a magnet adapted to magnetically engage a portion of the handle. As another example, a notch or other suitable detent may be cut into arms 202 and a pin may be mounted on or otherwise extend from handle 205 so that the pin engages the notch to retain the handle in an upwardly extending orientation. It is within the scope of the present disclosure that fence 120 may be formed without a retention mechanism or with a retention mechanism other than the magnet and pin-and-notch examples discussed above.

In the example of a clamping mechanism 200 shown in FIGS. 10 and 12-13, the clamping mechanism includes a cam surface 206 that is pivoted with the handle. Cam surface 206 may be attached to the handle, integrally formed with the handle, or otherwise suitably coupled to the handle for pivotal movement with the handle. As the handle is pivoted to configure the clamping mechanism from its unclamped position to its clamped position, the cam surface is moved to a position in which it engages the rail, or causes engagement of the rail by an intermediate structure, to secure the fence in a selected position relative to the rail and the table of the saw. When the handle is pivoted to release the clamping mechanism from its clamped position, the cam surface is pivoted with the handle to release or reduce the engagement with the rail so that the fence may again be slid or otherwise moved along the rail and the table. Cam surface 206 may also be referred to as a cam assembly or a cam portion of the clamping mechanism.

As referred to above, the cam surface may directly engage the rail to retain the fence in a selected position relative to the table and rail when the clamp assembly is in its clamped position. In some embodiments, it may be desirable for the cam surface to engage and urge an intermediate structure into engagement with the rail to retain the fence in a selected position when the clamp assembly is in the clamped position. For example, and while not required, the intermediate structure may be adapted to distribute the forces imparted by the cam surface, protect the rail from being marred or damaged by the cam surface, reduce torsional forces imparted by the cam surface that urge the distal portion of the work piece guide assembly away from the table, etc. This intermediate structure may be referred to as a distribution member or plate.

In FIGS. 12 and 13, an illustrative example of a suitable intermediate structure is shown in the form of a distribution plate 210 that is positioned to extend between the cam surface and the rail at least when the clamping mechanism is in the clamped position. As shown, the plate extends generally between the cam surface and bracket 160, with this region further including rail 122 when the fence is operatively positioned on a saw. In the illustrated example, plate 210 is pivotally mounted relative to arms 202. As perhaps best seen in FIGS. 12 and 13, a pin 208 extends between the arms, and plate 210 extends from the pin. When the fence is positioned on rail 122, the cam surface pushes plate 210 against the front wall of the rail, clamping the fence in place. As indicated graphically in FIG. 13, the plate may include a bearing, or wear, surface 212 that contacts rail 122 when the clamping mechanism is in the clamped position. Wear surface 212 may be formed from any durable material that is adapted to withstand the compressive forces imparted during the use of the clamping mechanism, and preferably which is selected to resist marring or other damage to the rail.

As a variant of a distribution plate 210 that is adapted to freely pivot relative to the rest of the clamping mechanism, the plate may be biased away from the bracket 160, such as by internal bias of the plate and/or by a biasing mechanism. Regardless of its implementation, the biasing mechanism should not exert sufficient bias to the plate to prevent the plate from being urged into engagement with the rail when the clamping mechanism is configured to its clamped position. However, it is sometimes necessary to remove the fence from the table. When replacing the fence into an operative position on the table and rail 122, a plate 210 that is freely pivotal, may be inadvertently pivoted into engagement with the top surface of the rail when the fence is being repositioned onto the table and rail. This may scratch or damage the rail and/or clamping mechanism. For example, plate 210 may include and/or take the form of a leaf spring that is biased away from bracket 160. As another example, the clamping mechanism may include a biasing mechanism, or member, such as a coil or other suitable spring, a resilient member, an elastic member, etc., that is adapted to urge the plate away from bracket 160. Biasing mechanism 160 may also be described as being adapted to urge, or bias, the distribution plate toward the cam surface of the clamping mechanism.

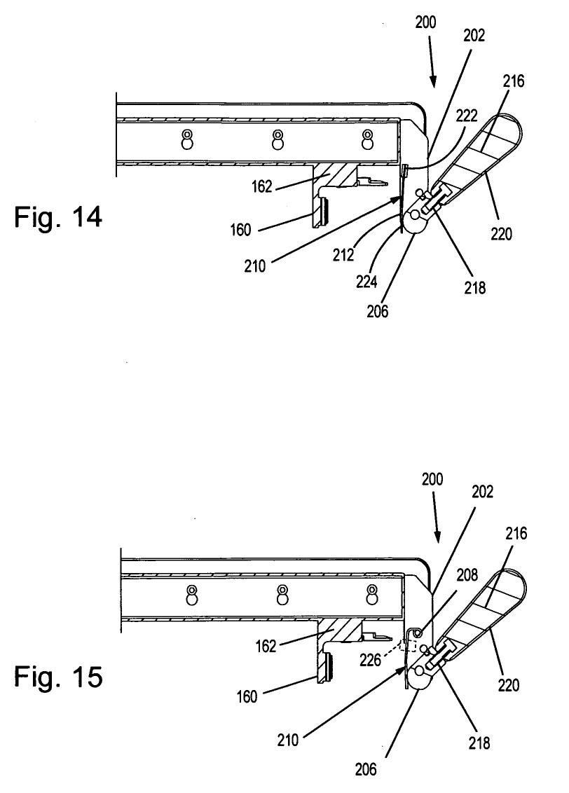

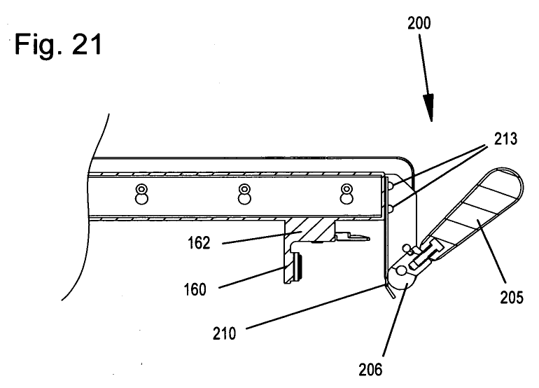

Illustrative (non-exclusive) graphical examples of the above-discussed biased distribution plates are shown in FIGS. 14, 15 and 21. In FIG. 14, the distribution plate includes a fixed end region 222 that is secured in a defined orientation relative to arms 202, and a free end 224 that is internally biased away from bracket 160. As discussed, this internal bias may be provided by the plate including or being a leaf spring or other resilient structure adapted to be biased away from bracket 160. In FIG. 15, the distribution plate is pivotally mounted relative to arms 202, such as in the examples shown in FIGS. 10-12. However, in FIG. 15, a biasing mechanism 226 is adapted to urge the plate away from bracket 160. Biasing mechanism 226 is illustrated schematically in dashed lines, with portions extending on both sides of the plate to graphically depict that the mechanism may be positioned in any suitable location relative to the plate to exert a desired bias to the plate. In FIG. 21, the distribution plate 210 is a piece of metal attached to support 128 by screws 213. Cam surface 206 flexes the plate toward bracket 160 when handle 205 pivots down. The plate itself acts as a leaf spring and returns to its original position when the handle is pivoted up. The bottom end of plate 210 may be bent away from bracket 160 in order to make it easier to place the fence on rail 122.

Plate 210 and/or surface 212 distribute the clamping force over an area of rail 122. While not required, in some embodiments it may be desirable for the plate and/or surface to be sized and configured to this area to be a relatively wide area of rail 122. Specifically, the plate and surface 212 may be sized and configured so that the force of clamping is distributed over a region of the side wall of rail 122 that includes an area where the top and/or bottom surfaces of the rail join the side wall. In that manner, the top and bottom walls of the rail help bear the force of clamping the fence in position, and that clamping force is less likely to bow or deform rail 122, which could affect the accuracy of the fence.

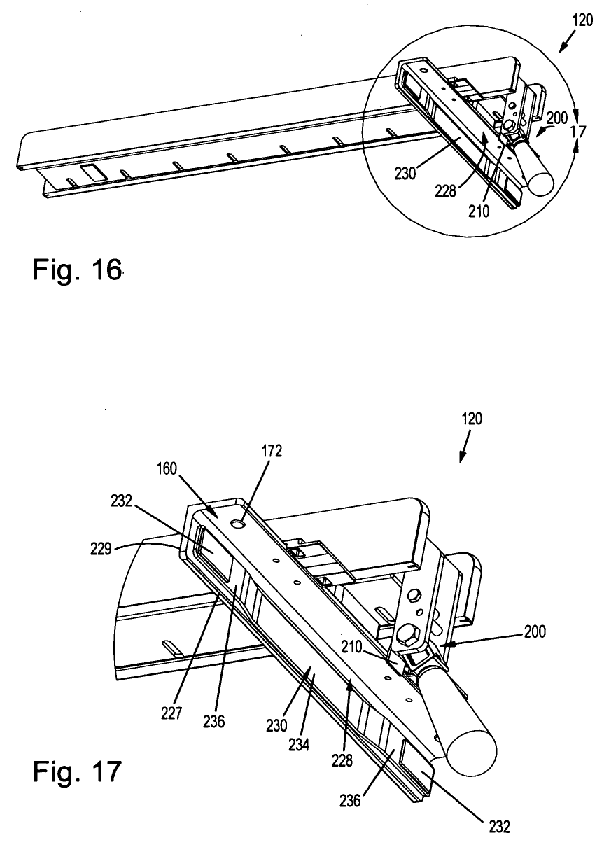

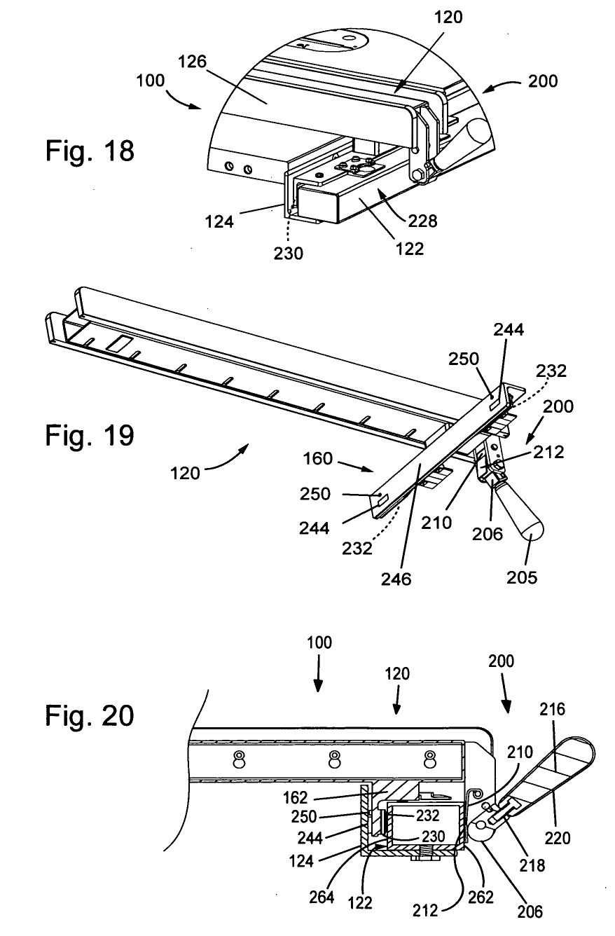

In at least FIGS. 16-17, fence 120 is shown including an adjustment plate 230 that is mounted on bracket 160 opposite clamping mechanism 200. Plate 230 may be described as being mounted on a clamp-facing, or guide-rail-facing, surface 227 of the vertical portion 163 of bracket 160. In other words, the adjustment plate and distribution plate 210 (and/or cam surface 206) define a region, or passage, 228 extending therebetween and into which the rail extends when the fence is operatively positioned on the saw. This is illustrated in FIG. 18, in which fence 120 is shown mounted on a saw 100, with rail 122 extending into passage 228. In use, adjustment plate 230 is adapted to engage one side of the rail, and distribution plate 210 (or cam surface 206) is adapted to engage the opposing side of the rail. It is within the scope of the present disclosure that fence 120 is formed without adjustment plate 230, but it may be desirable to include the adjustment plate.

In the illustrative example shown in FIG. 17, a center section 234 of the adjustment plate is welded, screwed or otherwise attached (such as depending upon the materials of construction being utilized) to bracket 160. The ends 236 of plate 230 are bent or otherwise extend away from the bracket and generally toward rail 122 when the fence is positioned on the saw's table with clamping mechanism 200 in engagement with, or suitably positioned to engage, rail 122. In the illustrative example, a pad, or glide plate, 232 is secured to each end of plate 230. The pads are adapted to contact the back wall of rail 122 when the fence is clamped in place on a saw. The glide plates are formed from a material that reduces the friction between the cross bracket and rail 122 when the fence is slid along the rail and these structures slidingly engage each other. Preferably, plates 232 are formed from a durable, low friction material. Plates 232 may be monolithic structures and/or may be formed from two or more materials and/or layers, such as by having a body, or core, and a low-friction surface layer adapted to contact the rail. Illustrative examples of suitable materials for plates 232, or at least contact surfaces thereof, include Teflon, ultra high molecular weight polyethylene (UHMW), and the like. Preferably, the pads are adapted to provide glide surfaces that provide for smoother sliding motion of the fence along rail 122 and which protect the fence and rail from being scratched or otherwise damaged when slid in contact with each other.

While not required, the pads may be sized so that when the fence is clamped in place, the clamping force is distributed over a region that is sized to include the area where either one or both of the top and bottom walls of the rail join with the back wall of the rail. By so doing, the top and bottom walls support the back wall during clamping and help prevent the back wall from bowing or deforming, which results in a more precise fence by holding the fence square. As a variation of this construction, adjustment plate 230 may be bowed instead of having a flat center section with ends that flare out.

As shown in FIG. 19, fences 120 according to the present disclosure may include one or more pads, or glide plates, 244 on the table-facing surface 246 of bracket 160. Glide plates 244 are adapted to contact bracket 124 and to provide for smoother sliding of the fence along rail 122, especially in situations where bracket 160 would engage bracket 124 and impinge the sliding motion imparted by a user and/or scratch or otherwise damage either of the contacting regions of these structures. When present, plates 244 are preferably formed from a durable material that preferably has less sliding friction against bracket 124 than surface 246 of cross bracket 160. Therefore, it is within the scope of the present disclosure that a fence 120 may include guide plates on neither, either one, or both of the table-facing and clamp-facing surfaces of bracket 160.

In the illustrative example shown in FIG. 19, glide plates 232 and 244 are shown aligned on opposing surfaces of cross bracket 160. This orientation is not required, as it is within the scope of the present disclosure to include more or less glide plates than illustrated in FIG. 19 and/or to have at least one of the glide plates that is not aligned with a corresponding glide plate on the opposing surface of cross bracket 160.

In FIG. 20, the illustrative fence of FIG. 19 is shown in a clamped position on a rail 122 of a table saw 100. As shown, cam surface 206 engages a distribution plate 210 and urges the contact surface 212 of the plate against one side wall 262 of rail 122. As also shown, the other side wall 264 of the rail is urged against adjustment plate 230. Preferably, the cam surface and/or distribution plate are oriented relative to each other and glide plates 232 so that the clamping force does not impart a torque vector that urges the distal end of support 128 away from the table. Even more preferably, although not required, the cam surface and/or distribution plate are oriented relative to each other and glide plates 232 to exert a torque, or force vector, to the work piece guide assembly that urges the distal end of the support and face(s) against the table.

FIG. 20 also illustrates that rail 122 may be secured upon bracket 124 by a plurality of bolts 123 that extend through corresponding apertures in the rail and bracket. Typically, a plurality of bolts spaced apart along the length of the rail and bracket are used. While precisely aligned apertures are within the scope of the present disclosure, in some embodiments, it may be desirable to oversize the apertures that extend through bracket 124 in a direction extending toward and away from the cabinet of the saw (i.e., transverse to the long axis of the bracket), as shown by aperture 125 in FIG. 20. These oversized, or oblong apertures enable the spacing of the rail relative to the bracket to be adjusted to accommodate bracket 160, should the need arise.

While not required to all embodiments, fence 120 preferably includes adjustment structure that is adapted to enable a user to adjust the orientation of the fence relative to the rail and/or table of the saw to precisely align, or tune, the fence for accurate, reproducible cuts. As discussed previously, the orientation of the one or more faces of the fence is selectively adjustable relative to the elongate support 128 of the fence.

Fence 120 may be adapted to provide adjustability in the squareness of the fence relative to the table of the saw. By this it is meant that is may be desirable to provide an adjustment mechanism that enables a user to adjust the clamped orientation of the fence so that the faces extend at a specific angle across the table. As a more specific example, adjustability may be desired if the distal end of the face (i.e., the end of the face that is farthest away from the clamping mechanism) is offset from the proximal, or opposite, end of the face about a vertical axis by more than an amount that is acceptable to a user. An illustrative example of a suitable adjustment structure for providing this adjustability is shown in FIGS. 13 and 19-20 and takes the form of adjustable screws or other projections 250 that extend through the back of bracket 160 behind the ends of adjustment plate 230. Threading the projections in or out adjusts how far the ends of adjustment plate 230 extend away from the bracket. By so doing, a user can adjust how the fence sits on rail 122 and thereby square-up the fence relative to the saw.

Projections 250 may also be positioned so that they are above the point where cam surface 206 clamps plate 210 against rail 122, as seen in FIG. 20. That geometry causes the distal end of support 128 to tend to pivot down against the table top when the fence is clamped to the rail, instead of moving up.

As indicated in FIG. 3, cross bracket 160 may include leveling screws 172 which may be selectively extended or retracted to level the fence relative to the tabletop of the saw to adjust the orientation or the fence relative to the table about a horizontal axis extending along the length of support 128. In FIG. 9, a pair of leveling screws 172 are shown threadingly extending through corresponding holes in a horizontal portion 161 of bracket 160. Screws 172 are typically made of plastic, but any other suitable material may be used. A material that will not scratch the rail may be preferred, as the screws in the illustrative example will slide over the top of rail 122 when the position of the fence along the rail is adjusted.

As also indicated in FIG. 3, rail 122 may be equipped with a ruler or measuring tape on its top surface, and bracket 160 may include one or more cross-hair positioning guides 170 to indicate the position of the fence relative to the blade of the saw. The positioning guides are made of clear plastic and they include at least one score line 171 (indicated in FIG. 3) on the underside of each guide that may be aligned with marks on the ruler. Scoring the positioning guides on the undersurface instead of on the top protects the score lines from scratches and wear.

In the illustrative figures presented herewith, fences 120 according to the present disclosure have been illustrated incorporating many different features and/or components that are described herein. It is within the scope of the present disclosure that a fence may be constructed with only selected subsets, or even a single one, of the disclosed features and/or components, either alone or in combination with other features and/or components.

### INDUSTRIAL APPLICABILITY

The fences and components disclosed herein are applicable to table saws and other power equipment.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub-combinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A table saw fence system adapted to be operatively positioned on a table saw to guide movement of a work piece on the table saw, the fence system comprising:
an elongate guide rail;
a bracket adapted to mount the guide rail to the table saw and hold the guide rail away from the table saw to define a channel between the table saw and the guide rail, where the position of the guide rail relative to the bracket is adjustable so that a distance across the channel from the guide rail to the table saw is adjustable;
a work piece guide adapted to be positioned on the table saw to guide movement of a work piece on the table saw;
a cross bracket coupled to the guide and extending perpendicular thereto, wherein the cross bracket includes a portion adapted to fit into the channel between the table saw and the guide rail; and
a clamping mechanism adapted to selectively secure the cross bracket in a selected position on the guide rail.

2. The table saw fence system of claim 1, where the bracket includes a plurality of oversized apertures, and where the guide rail is secured to the bracket by bolts that pass through the oversized apertures.

3. The table saw fence system of claim 2, where the apertures are oversized in a direction extending toward and away from the table saw.

4. The table saw fence system of claim 2, where the apertures are oblong in a direction extending toward and away from the table saw.

5. The table saw fence system of claim 1, wherein the portion of the cross bracket adapted to fit into the channel has a table-facing surface and a rail-facing surface generally opposed to the table-facing surface, and further comprising two glide plates mounted on the table-facing surface.

6. The table saw fence system of claim 5, wherein the cross bracket is elongate with two ends and a midpoint, and wherein one glide plate is between the midpoint and one end of the cross bracket and the other glide plate is between the midpoint and the other end of the cross bracket.

7. The table saw fence system of claim 5, further comprising two additional glide plates mounted on the cross bracket to engage the guide rail.

8. The table saw fence system of claim 1, wherein the cross bracket includes an adjustment plate mounted on the portion of the cross bracket adapted to fit into the channel between the table saw and the guide rail, wherein the adjustment plate is held in a spaced-apart relationship to the clamping mechanism to define a passage sized to selectively receive the guide rail, wherein the adjustment plate includes opposed end regions that are biased to extend generally toward the clamping mechanism, wherein the cross bracket includes projections that adjustably extend through the cross bracket and into engagement with the end regions of the adjustment plate to hold the end regions selected distances away from the cross bracket, and wherein the adjustability of the channel between the guide rail and the table saw accommodates the cross bracket and adjustment plate when the projections hold the end regions selected distances away from the cross bracket.

9. The table saw fence system of claim 8, wherein the portion of the cross bracket adapted to fit into the channel has a table-facing surface and two glide plates mounted on the table-facing surface.

10. The table saw fence system of claim 9, further comprising two additional glide plates, one mounted on each of the opposed end regions of the adjustment plate.

11. A table saw fence system adapted to be operatively positioned on a table saw to guide movement of a work piece on the table saw, the fence system comprising:
a bracket adapted to be secured to the table saw;
a guide rail adapted to be secured to the bracket; and
a fence supported by the guide rail and adapted to be secured in selected positions on the guide rail;
where the bracket is adapted to hold the guide rail a distance away from the table saw to define a channel between the guide rail and the table saw;
where the fence includes a portion adapted to fit into the channel; and
where the bracket is further adapted so that the distance across the channel between the guide rail and the table saw is adjustable.

12. The table saw fence system of claim 11, where the bracket includes a plurality of oversized apertures, and where the guide rail is secured to the bracket by bolts that pass through the oversized apertures.

13. The table saw fence system of claim 12, where the apertures are oversized in a direction extending toward and away from the table saw.

14. The table saw fence system of claim 13, where the bracket is elongate and where the apertures are oversized in a direction transverse to the long axis of the bracket.

15. The table saw fence system of claim 12, where the apertures are oblong in a direction extending toward and away from the table saw.

16. The table saw fence system of claim 15, where the bracket is elongate and where the apertures are oblong in a direction transverse to the long axis of the bracket.

17. The table saw fence system of claim 11, wherein the portion of the fence adapted to fit into the channel has a table-facing surface and a rail-facing surface generally opposed to the table-facing surface, and further comprising two glide plates mounted on the table-facing surface.

18. The table saw fence system of claim 17, further comprising two additional glide plates mounted on the rail-facing surface.

19. A table saw fence system adapted to be operatively positioned on a table saw to guide movement of a work piece on the table saw, the fence system comprising:
a guide rail;
a bracket adapted to be secured to the table saw and to hold the guide rail a distance away from the table saw to define a channel between the guide rail and the table saw;
a fence supported by the guide rail and adapted to slide along the guide rail and to be secured in selected positions on the guide rail, where the fence includes a portion adapted to fit into the channel; and
means for adjusting the distance the bracket holds the guide rail away from the table saw.

20. The table saw fence system of claim 19 further comprising glide means associated with the fence for facilitating smooth sliding of the fence along the guide rail.
